(19) United States
(12) Patent Application Publication
(10) Pub. No.: US 2021/0318840 A1
(43) Pub. Date: Oct. 14, 2021

(54) PRINTING RELEVANT CONTENT

(71) Applicant: Hewlett-Packard Development Company, L.P., Spring, TX (US)

(72) Inventors: Devraj Singh, Bangalore (IN); Gurpreet Singh Bhatia, Bangalore (IN)

(73) Assignee: Hewlett-Packard Development Company, L.P., Spring, TX (US)

(21) Appl. No.: 17/267,512

(22) PCT Filed: Sep. 19, 2019
(86) PCT No.: PCT/US2019/051857

§ 371 Date: Feb. 10, 2021

(30) Foreign Application Priority Data
Nov. 19, 2018 (IN) IN201841043554

(51) Int. Cl. G06F 3/12; G06K 9/00; G06K 9/62; G06N 20/00; G06N 5/04

(52) U.S. Cl. CPC G06F 3/1208; G06K 9/00456; G06N 5/04; G06K 9/6263; G06N 20/00; G06F 3/1256

(57) ABSTRACT

The present subject matter relates to techniques of printing contents within a webdocument that are relevant for printing. In one example, the web document including a plurality of content may be received and thereafter, each content in the web document may be classified as one of relevant or non-relevant for printing. In one example, the classification may be done by analyzing metadata associated with the contents using machine learning techniques. Further, the contents classified as relevant may be sent for printing.

### BACKGROUND

A web document, such as a web page, a post on a social networking site, or an electronic mail (E-mail), on a user device may be printed through the user device connected to a printing device over a wired or wireless network. Generally, the web document may include various type of content, such as texts, images, advertisements banners, and hyperlinks to another web page or a website. In some cases, the web document may be sent to a server external to the user device for printing the web document.

### BRIEF DESCRIPTION OF DRAWINGS

The detailed description is provided with reference to the accompanying figures, wherein:

FIG. 1 illustrates an example of a network environment employing a user device for printing relevant content in a web document;

FIG. 2 illustrates the user device for printing relevant content in the web document, according to an example;

FIG. 3 illustrates a detailed schematic of the user device for printing relevant content in the web document, according to an example;

FIG. 4 illustrates a method for printing relevant content in the web document, according to an example;

FIG. 5 illustrates a flow diagram indicating a process of printing relevant content in the web document, according to an example; and

FIG. 6 illustrates a non-transitory computer readable medium, according to an example.

### DETAILED DESCRIPTION

Generally, when a web document is printed, certain non-relevant content, such as advertisements and hyperlinks, may also be printed along with the contents of interest. The printing of such non-relevant content may also result in unnecessary consumption of ink and paper. As a result, the printing of the non-relevant content may result in wastage of both ink and paper. In a few cases, the web document may be analyzed before printing to identify whether a certain content is relevant or non-relevant for printing. Accordingly, the contents of the document, for instance, the text and images, may be analyzed to differentiate the relevant content from the non-relevant content. Since such printing may generally be hosted by a third-party, for instance, in the form of a third-party print-service hosted on a server, such analysis may involve sharing of the contents of the web document with the third-party. However, such foreign access to the contents may compromise privacy and security of the web document. Moreover, analyzing the contents in the web document may be a computationally intensive task and may need considerable amount of processing resources. As a result, analyzing the contents may add to the time taken for printing the web document, thereby causing latency in the printing process.

Examples for printing contents within a web-document that are relevant for printing are described. According to an example, a web document may be received by a user device for printing, the web document having a plurality of contents. Once the web document is received, the contents within the web document may be classified as relevant or non-relevant based on the metadata associated with each content. Once the contents are classified, the contents that are classified as relevant may be sent to a printing device for printing.

In one example, the contents classified as relevant or non-relevant for printing may be rendered to the user to obtain a user's feedback on the classification. Further, based on user's feedback, the contents classified as relevant may be sent for printing. Simultaneously, the user's feedback may be stored and may be used to classify the contents in future.

According to one example, a request for printing the web document is received by the user device, the request may include user defined parameters. In one example, the user defined parameters may be a type of printing paper, a size of printing paper, a type of printing device, or the like. Further, the user defined parameters may be used to restructure or reorganize the contents in the web document prior to printing the web document.

In one example, the contents in the web document may be identified. Further, the contents may be identified by analyzing a document layout of the web document that may include details related to a type of content, a position of the content, or the like.

Once the contents are identified, metadata associated with each identified content may be analyzed. In one example, the metadata may be analyzed based on predetermined rules to classify each content as relevant or non-relevant for printing. For instance, the metadata of the contents may be analyzed using machine learning techniques.

In one example, the contents that are classified as relevant for printing may be sent for printing. Alternatively, a preview of the web document may be rendered to the user that shows the contents and the classification associated with the contents. In one example, a user interactive device may render a preview of the web document including the contents and the classification of the content. Further, the interactive user-interface device may receive an input from the user in the form of a user's feedback on the classification. In one example, when the user confirms that the classification of the contents is correct, the contents classified as relevant may be sent for printing to a printing device by the user device. According to an example, in case the user updates the classification of one or more contents, the contents that are classified as relevant based on the user's feedback are sent for printing. Simultaneously, the updates in the classification may be used to learn the user's choice for classifying the contents in future. As a result, the contents can be classified accurately in future.

The techniques based on the present subject matter may classify the contents as relevant or non-relevant for printing. Further, the techniques based on the present subject matter may print the contents that are classified as relevant. As a result, the techniques based on the present subject matter prevents wastage of ink and paper, that otherwise would have occurred if the non-relevant content are printed. Moreover, the techniques based on the present subject matter may also ensure security of the web document because the techniques based on the present subject matter does not read the matter inside the contents. Further, the techniques based on the present subject matter does not store any contents for classification, and therefore, the classification of the contents may be done efficiently since the content is neither stored nor analyzed. Further, according to one aspect, the techniques based on the present subject matter may take the feedback on the classification of the contents from the user to learn the user's choice in order to classify the contents in future. As a result, the techniques based on the present subject matter adapt to the user's behavior to accurately classify the contents. Moreover, the techniques based on the present subject matter provides the interactive user-interface allowing the user to review the classification thereby providing good experience to the user.

The above aspects are further described in conjunction with the figures, and in associated description below. It should be noted that the description and figures merely illustrate principles of the present subject matter. Therefore, various assembly that encompass the principles of the present subject matter, although not explicitly described or shown herein, may be devised from the description and are included within its scope. Additionally, the word “coupled” is used throughout for clarity of the description and can include either a direct connection or an indirect connection.

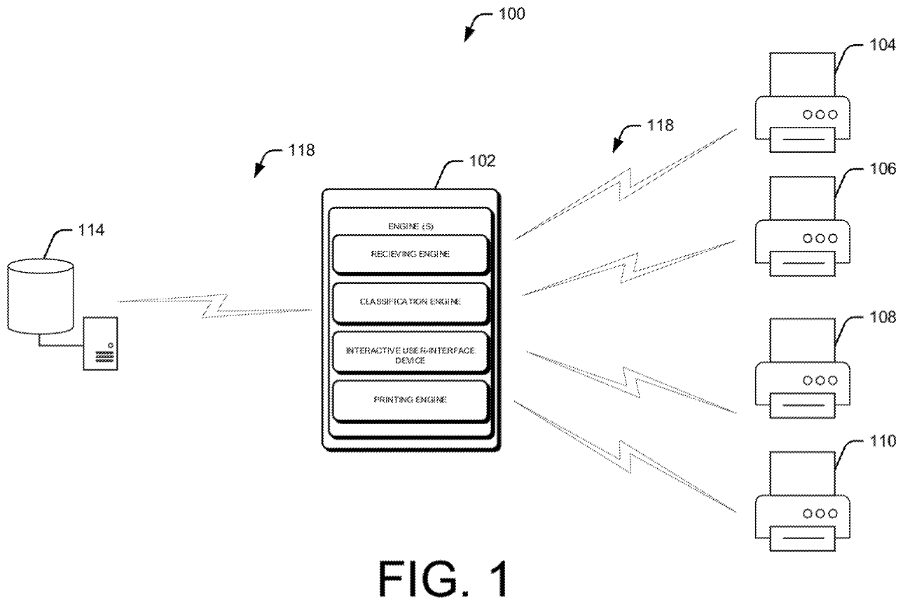

FIG. 1 illustrates a network environment 100 that may include a user device 102 for printing relevant contents in a web document. In one example, the user device 102 may include engines, such as a receiving engine, a classification engine, an interactive user interface device, and a printing engine that may work in conjunction to print relevant content in the web document. For instance, the user device 102 can be a mobile phone, a laptop, a handheld PC, or the like. According to an example, the network environment 100 may include printing devices 104, 106, 108, and 110 that may be connected to the user device 102 through a communication network 112.

The communication network 112 may be a wireless network, a wired network, or a combination thereof. The communication network 112 can also be an individual network or a collection of many such individual networks, interconnected with each other and functioning as a single large network, e.g., the Internet or an intranet. The communication network 112 can be employed as one of the different types of networks, such as intranet, local area network (LAN), wide area network (WAN), the internet, and such. The communication network 112 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the communication network 112 may include network devices (not shown), such as network switches, hubs, routers, for providing a link between the user device 102 and the printing devices 104, 106, 108, and 110. The network devices within the communication network 112 may interact with the user device 102 and the printing devices 104, 106, 108, and 110 through the communication links. In one example, the network environment 100 may include internet 114 that may be connected to the user device 102 through the communication network 112. Further, the internet 114 may be formed of a plurality of servers that may provide web documents to the user device 102 upon receiving a request from the user device 102.

The user device 102 based on the present subject matter may interact with the internet 114 to receive the web document and the user device 102 may also interact the printing devices 104, 106, 108, and 110 to print contents of the web document that the user device 102 classifies as relevant for printing.

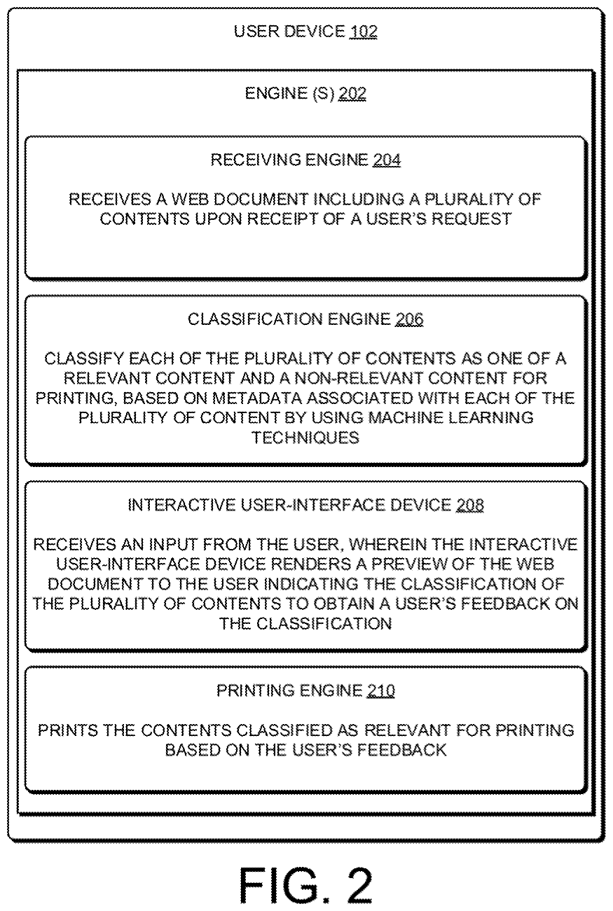

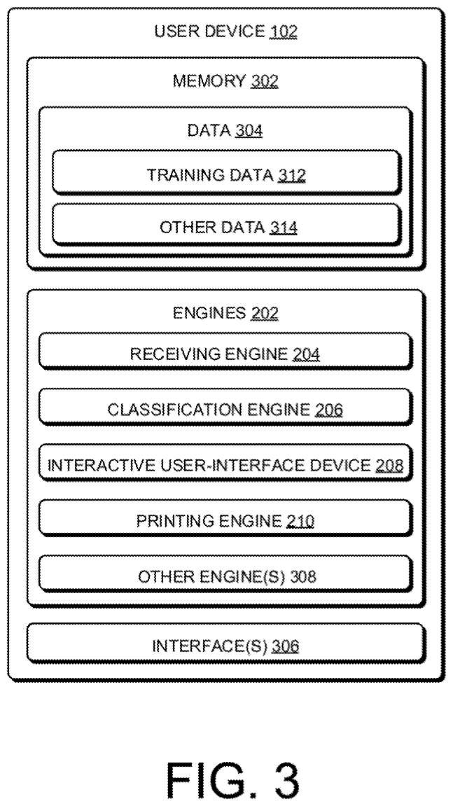

In operation, the user device 102 may receive a request from a user to print a web document. In one example, the web document can be a web page or an electronic mail (E-mail), that the user device 102 may retrieve using a web browser. Upon receipt of the request, the user device 102 may retrieve the web document. Once the web document is retrieved, the user device 102 may classify the contents as relevant or non-relevant for printing. For instance, the user device 102 may analyze metadata associated to the contents being analyzed to classify the contents as relevant or non-relevant. Further, since the user device 102 classifies the contents based on the metadata, the contents may be classified without analyzing the data of the content. Once the contents are classified, the user device 102 may print the contents that are classified as relevant for printing. A manner by which the user device 102 operates is explained with respect to FIG. 2 and FIG. 3, as an example.

FIG. 2 illustrates the user device 102 to print contents relevant for printing, according to an example. The user device 102 may include, for example, engines 202. The engines 202 are employed as a combination of hardware and programming (for example, programmable instructions) to use functionalities of the engines 202. In examples described herein, such combinations of hardware and programming may be used in a number of different ways. For example, the programming for the engines 202 may be processor executable instructions stored on a non-transitory machine-readable storage medium and the hardware for the engines 202 may include a processing resource (for example, processors), to execute such instructions. In the present examples, the machine-readable storage medium stores instructions that, when executed by the processing resource, deploy engines 202. In such examples, user device 102 may include the machine-readable storage medium storing the instructions and the processing resource to execute the instructions, or the machine-readable storage medium may be separate but accessible to the user device 102 and the processing resource. In other examples, engines 202 may be deployed using electronic circuitry.

The user device 102 may include a receiving engine 204 that may retrieve the web document when the user provides a request to print the web document. The receiving engine 204, in one example, when the request to print is received, the user device 102 may receive the web document. In one example, the user device 102 may also include a classification engine 206 that may classify the contents as relevant or non-relevant for printing using machine learning techniques. For instance, the classification engine 206 may classify the content based on a metadata associated with each content.

The user device 102 may also include an interactive user-interface device 208 that may provide the user with the classification to obtain an input from the user on the classification. In one example, the interactive user-interface device 208 can be, as example, a touch screen display, a graphic user interface on a display device. For instance, the interactive user-interface device 208 may render a preview of the web document indicating the classification of each contents to obtain the user's feedback. Further, the user may provide the feedback on the classification through the interactive user-interface device 208. The user device 102 may also include a printing engine 210 that may print the contents that are classified as relevant for printing based on the user's feedback. In one example, the printing engine 210 may send the relevant content to one of the printing devices 104, 106, 108, and 110 (shown in FIG. 1) for printing.

FIG. 3 illustrates a detailed schematic of the user device 102 to print contents relevant, according to an example of the present subject matter. The user device 102, among other things and in addition to the engines 202, a memory 302 having data 304, and interface(s) 306 may include other components. The engines 202, among other capabilities, may fetch and execute computer-readable instructions stored in the memory 302. The memory 302, communicatively coupled to the engines 202, may include a non-transitory computer-readable medium including, for example, volatile memory, such as Static Random-Access Memory (SRAM) and Dynamic Random-Access Memory (DRAM), and/or non-volatile memory, such as Read-Only-Memory (ROM), erasable programmable ROM, flash memories, hard disks, optical disks, and magnetic tapes.

In an example, in addition to the receiving engine 204, the classification engine 203, the interactive user-interface device 208, and the printing engine 210, the engines 202 may include other engine(s) 308. The other engine(s) 308 may provide functionalities that supplement applications or functions performed by the user device 102.

Further, the data 304 includes data that is generated as a result of the functionalities carried out by any of the engines 202. The data 304 may include training data 312 other data 314. The other data 314 may include data generated and saved by the engines 202 to provide various functionalities to the user device 102.

In one example, the classification engine 206 of the user device 102 may classify the contents either based on a trained machine learning model. In another example, the classification engine 206 may be trained to classify the content. An example, of training the user device 102 is explained further. In operation, the receiving engine 204 may receive a request to print the web document. Thereafter, the receiving engine 204 may receive the web document and shares the web document to the classification engine 206. Further, the classification engine 206 may identify the contents and shares the identified contents to the interactive user-interface device 208 to allow the user to provide feedback on the classification. Upon receiving the user feedback, the interactive user-interface device 208 may send the content classified as relevant. Simultaneously, the classification provided by the user is stored as the training data 312.

According to an example, the user device 102 may be trained by receiving inputs from the users. In one example, the receiving engine 204 may receive a request from the user to print the web document. In one example, the receiving engine 204 may send an instruction to the web server to send the web document to the user device 102. Once the instructions are received, the web server may send the requested web document to the user device 102.

Upon the receipt of the web document, the classification engine 206 may analyze the web document for further processing. As part of the training, in one example, the classification engine 206 may analyze a document layout of the web document to identify the content. Further, the classification engine 206 may identify the content to determine the number of contents, and types of contents in the web document. In one example, the classification engine 206 may identify an HTML layout that includes various information, such as, but not limited to, headers, sections of the web documents. For instance, the classification engine 206 may parse the document layout to identify the type of content or a position of the content in the web document or both. Further, the classification engine 206 may assign an identifier to each unique type of contents. Further, the classification engine 206 may create a table indicating the contents and their type along with the identifier associated with each content.

Once the contents are identified, the interactive user-interface device 208 may generate a preview of the web document and the contents inside the web document to receive a classification from the user. In one example, the interactive user-interface device 208 may provide the preview that may include a print preview of the web document with an input interface overlay around each content. For instance, the input interface can be a checkbox allowing the user to select or de-select the checkbox. Further, a tick in the checkbox represents that the user has classified the contents as relevant for printing. In one example, the interactive user-interface device 208 may create input interfaces for each content. Further, in case the interactive user-interface device 208 determines that the number of identified contents exceeds a predetermined threshold, such as ten or fifteen, the interactive user-interface device 208 may create a single input interface of the contents that have the same identifier. For instance, the interactive user-interface device 208 may group the contents in order to provide the user with fewer input interfaces for selection since presenting the user with multiple input interface may not be intuitive for the user.

Once the interactive user-interface device 208 has presented the preview, the user may classify the content. In one example, the user may classify the contents as relevant by the ticking the checkbox in the input interface. Once the user has finished classifying the contents, the interactive user-interface device 208 may send the classification to the classification engine 206 that may add the classification of each content against corresponding identifier in the table and stores them as the training data 312. For instance, the classification engine 204 may create the training data 312 by extracting the metadata for the content and populating the metadata in the form of a grid or a 2-D array to the corresponding identifier. In one example, the classification engine 206 may associate a classification tag for each metadata that may act as an indicator that indicate the classification of the content. For instance, the classification engine 206 may associate a first classification tag to all the contents that are classified as relevant for printing and a second classification tag to all the contents that the classified as non-relevant for printing.

According to an example, the interactive user-interface device 208 may send the contents classified as relevant for printing. In one example, the user device 102 receive the classification from the user until the user device 102 has adequate information on the classification of the contents and their type. Once the user device 102 has adequate training data 312, the user device 102 may now perform classification of the content.

Once the user device 102 is trained, the user device 102 may be deployed to classify the content. An example of how the user device 102 classifies the contents based on a trained machine learning model is explained further. For instance, the user device 102 may first receives the web documents from the web server and thereafter, processes the web document by classifying each content in the web document as relevant or non-relevant for printing. Once the contents are classified, the user device 102 may present the classification to the user to obtain the feedback from the user. Based on the feedback, the user device 102 may print the contents classified as relevant based on the feedback.

In one example, the receiving engine 204 may receive a request from the user to print the web document. In one example, the receiving engine 204 may send an instruction to the web server to retrieve the web document. Once the instructions are received, the web server may send the requested web document to the user device 102. Upon the receipt of the web document, the classification engine 206 may analyze the web document for further processing. For instance, the classification engine 206 may analyze a document layout to identify the content. In one example, the classification engine 206 may identify an HTML layout that includes various information, such as, but not limited to, headers, sections of the web document. Further, the classification engine 206 may parse the document layout and may assign an identifier to each unique type of contents by the classification engine 206. In one example, the classification engine 206 may associate the identifier to unique contents in order to facilitate the classification of same type of content.

According to an example, the classification engine 206 may classify the identified contents. In one example, the classification engine 206 may analyze the metadata associated with each content. The metadata may be understood as a set of information or codes having instructions indicating the type of the content. According to one example, the classification engine 206 may employ supervised machine learning framework and logistic regression model to analyze the metadata. For instance, the classification engine 206 may use probabilistic classifying techniques, such as logistic regression modelling technique, Naïve Bayer Classifier technique, Decision Trees technique, Support vector machines machine algorithm, to analyze the metadata. For instance, the logistic regression modelling technique may be a predictive analysis that may be used to describe data the relationship therebetween to obtain a binary output. Further, the classification engine 206 may classify the contents based on the metadata associated with the content. In one example, the classification engine 206 may analyze the metadata of the contents to identify the relevancy of the contents and accordingly, may classify the contents as relevant or non-relevant.

In one example, the classification engine 206 may use a trained dataset, such as the training data 312 that may include the classification made for contents, having similar metadata, made in the past by the user and use the trained dataset for training the classification engine 204. Further, based on the trained machine learning model and the metadata, the classification engine 206 may classify the contents in the web document as relevant or non-relevant for printing.

Once the classification engine has classified the contents, the classification engine 206 may send the contents classified as relevant for printing. Alternatively, the classification engine 206 may present the classification to the interactive user-interface device 208 to render the web document and the classification. In one example, the interactive user-interface device 208 may render a preview of the web document along with the classification such that the preview may of the web document may indicate a view of the printed document. Further, the interactive user-interface device 208 may also form input interfaces for the contents. For instance, the interactive user-interface device 208 may determine if the number of identified contents are more than the predetermined threshold and if number of identified contents exceeds the predetermined threshold, the interactive user-interface device 208 may group the identified contents such that a single input interface may be formed for the grouped contents. For instance, the interactive user-interface device 208 may form single input interface for the contents of same type. Further, the interactive user-interface device 208 may group the contents such that the number of input interfaces formed are less than the predetermined threshold.

According to an example, once the input interfaces are formed, the interactive user-interface device 208 may configure the input interfaces based on the classification of the content. For instance, the interactive user-interface device 208 may keep add tick in the checkbox for the contents that are classified as relevant for printing. On the other hand, the interactive user-interface device 208 may keep the checkbox of the input interface unchecked for the contents that are classified as non-relevant for printing. Once the input interfaces are formed, the interactive user-interface device 208 may present the preview to the user to obtain a feedback on the classification.

Thereafter, the user may provide the feedback on the classification. In one example, the user may change the classification of one or more contents if the user determines that the classification of the contents is incorrect. In one example, the user may deselect a checkbox for the contents that was classified as relevant by the user device 102 but may not be relevant according to the user. In another example, the user may put a check in a checkbox for the contents that was classified as non-relevant but may be relevant according to the user. Once the user has updated the classification, the user may provide a command to the interactive user-interface device 208 to proceed with printing of the contents that are classified as relevant for printing based on the user's feedback. Upon receipt of the command, the interactive user-interface device 208 may send the contents relevant for printing to the printing engine 210. Simultaneously, the interactive user-interface device 208 may send the updates in the classification back to the classification engine 206 that may update the training data 312 based on the feedback. In one example, the classification engine 206 may record the updates in the classification of the contents, associates the updated classification with the identifier, and stores the update in the training data 312. Further, the update in the classification may be used in future to classify similar content. Further, the training data 312 stores the classification but not the contents itself. In other case, if the user finds the classification is correct, the user may provide a command to the interactive user-interface device 208 to proceed with the printing of the contents classified for printing. In this case, no updates in the classification is the user's feedback on the classification. Thereto, the interactive user-interface device 208 may send the contents classified as relevant for printing based on the user's feedback.

According to an example the printing engine 210 may receive the contents classified as relevant for printing based on user's feedback. In one example, the printing engine 210 may also receive the preview of the web document including the contents classified relevant for printing and not the contents classified as non-relevant. Upon receipt of the contents, the printing engine 210 may restructure or reorganize the contents in the preview such that the printed document does not have any inconsistency due to omission of the contents classified as non-relevant. In one example, the printing engine 210 may also format the preview based on the user defined parameters, for instance, font of the content, dimensions of the printing paper, type of the printing device. Once the printing engine 210 has updated the preview, the printing engine 210 may send the updated preview to the printing device for printing. Further, upon receipt of the updated preview by the printing device, the printing device may print the contents classified as relevant for printing.

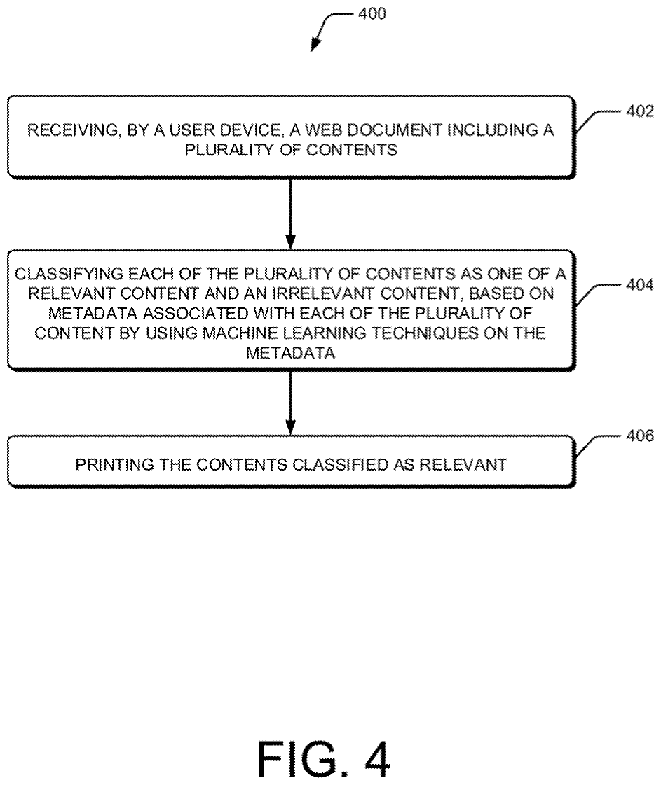

FIG. 4 illustrates a method 400 for printing a web document according to an example of the present subject matter. The method(s) may be described in the general context of computer executable instructions. Generally, computer executable instructions can include routines, programs, objects, components, data structures, procedures, engines, functions, etc., that perform particular functions or employ particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to employ the method 400, or an alternative method. Additionally, individual blocks may be deleted from the methods without departing from the spirit and scope of the subject matter described herein. Furthermore, the methods 400 can be employed in any suitable hardware, software, firmware, or combination thereof. The method 400 is explained with reference to the user device 102, however, the methods can be employed in other systems as well.

Referring to method 400, at block 402, a web document may be received by a user device 102. In one example, the web document may include a plurality of content. Further, the web document may be received from a web server upon receipt of a request by the user to print the web document. Once the web document is received the method 400 moves to next step.

At block 404, the contents may be classified as relevant or non-relevant for printing using machine learning techniques. In one example, a metadata may be analyzed using machine learning techniques to classify the content.

Finally, at block 406, the contents that are classified as relevant may be sent for printing. Further, the contents may be reorganized such that the printed document does not have any inconsistency due to omission of the contents classified as non-relevant based on user defined parameters for printing.

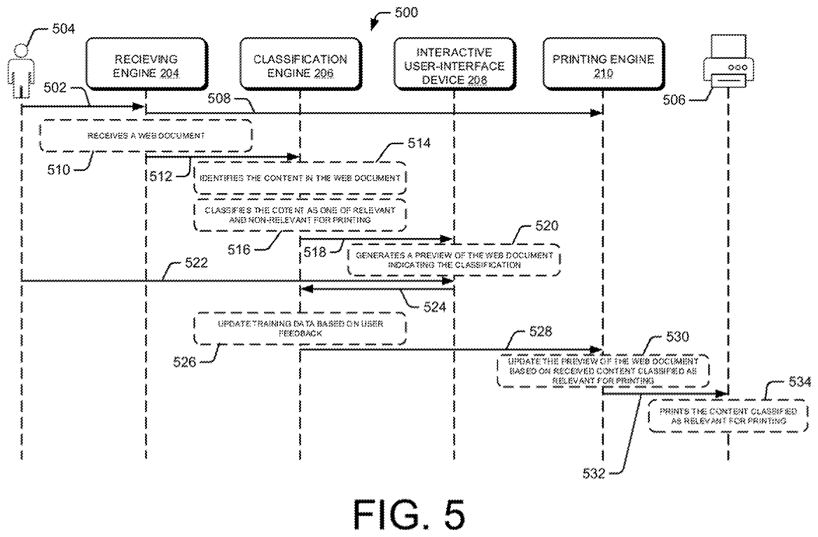

FIG. 5 illustrates a flow diagram 500 for printing the contents classified as relevant for printing, according to an example. The various arrow indicators used in the call-flow diagram 500 depict the transfer of web document and contents between different engines of the user device 102 (shown in FIG. 3). Although the description of FIG. 3 has been made in considerable detail with respect to the access network, it will be understood that the steps for printing the contents relevant for printing can be employed in other networks as well, albeit with few alterations. Further, certain trivial steps have been omitted in the sequence diagrams, for the sake of brevity and clarity.

Referring to FIG. 5, at step 502, a user 504 may send a request to the receiving engine 204 to print a web document using a printing device 506. In one example, the request may include the instructions to print the web document and user defined parameter. Further, at step 508, the receiving engine 204 may communicate the user defined parameters to the printing engine 210. Simultaneously, at step 510, the receiving engine 204 may receive the web document. Upon the receipt of the web document, the receiving engine 204 may send the web document to the classification engine 206 for further analysis as shown in step 512.

At step 514, the classification engine 206 may identify the contents in the web document. As mentioned before, the classification engine 206 may identify the contents using the document layout of the web document. In one example, the classification engine 206 may parse the document layout to identify the position of the content in the web document and the type of the content. Further, at step 516, the classification engine 206 may classify the identified contents as either relevant or non-relevant for printing. In one example, the classification engine 206 may classify the contents in a manner explained with respect to FIG. 3. Once the contents are classified, the classification engine 206 may send the web document and the classification to the interactive user-interface device 208 as shown by step 518. Thereafter, at step 520, the interactive user-interface device 208 may generate a render of the web document. A manner by which the preview is rendered is already explained with respect to FIG. 3 and hence, is not repeated for brevity.

Once the preview is generated, the interactive user-interface device 208 may receive a feedback from the user as shown by step 522. In one example, the interactive user-interface device 208 may present a preview of the web document along with input interface for each classified content to receive the feedback. Further, at step 524, the interactive user-interface device 208 may send the feedback to the classification engine 206. Upon receipt of the feedback, the classification engine 206 may update the training data 312 as shown in step 526. Further, at step 530, the preview of the web document and classification of the contents after the user's feedback are sent to the printing engine 208 as shown in step 528 where the printing engine 210 may update the preview of the web document based on the user defined parameters, as shown in step 530. Further, at step 532, the printing engine 210 may send an updated preview to the printing once the preview is updated. Lastly, at step 534, the printing device 506 may print the contents that are classified as relevant for printing and verified by the user.

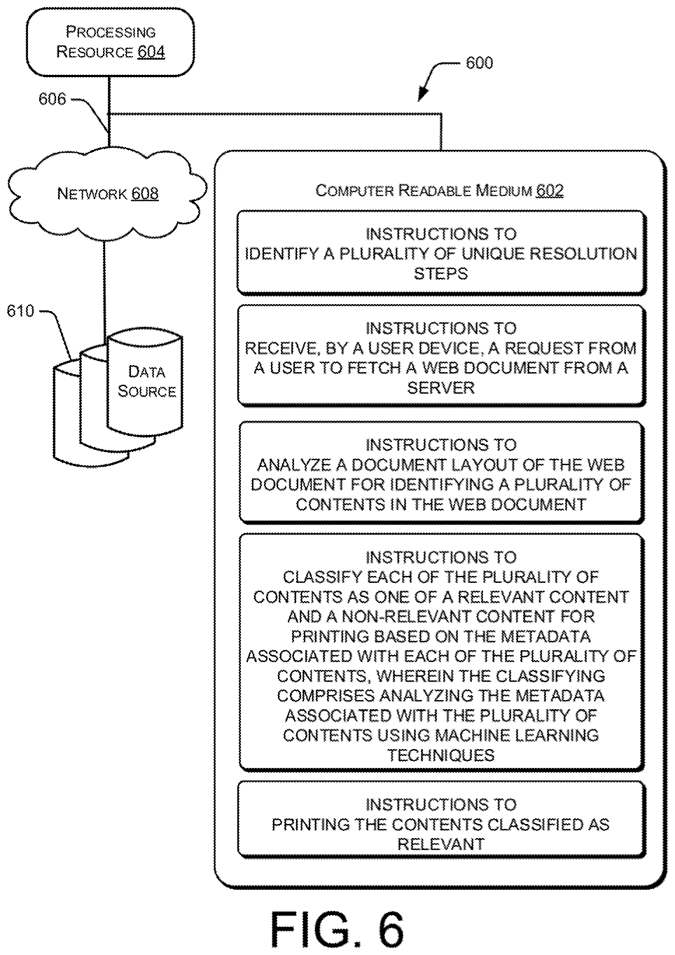

FIG. 6 illustrates an example network environment 600 using a non-transitory computer readable medium 602 to assign the mobility factor, according to an example of the present subject matter. The network environment 600 may be a public networking environment or a private networking environment. In one example, the network environment 600 includes a processing resource 604 communicatively coupled to the non-transitory computer readable medium 602 through a communication link 606.

For example, the processing resource 604 may be a processor of a computing system, such as the user device 102. The non-transitory computer readable medium 602 may be, for example, an internal memory device or an external memory device. In one example, the communication link 606 may be a direct communication link, such as one formed through a memory read/write interface. In another example, the communication link 606 may be an indirect communication link, such as one formed through a network interface. In such a case, the processing resource 604 may access the non-transitory computer readable medium 602 through a network 608. The network 608 may be a single network or a combination of multiple networks and may use a variety of communication protocols.

The processing resource 604 and the non-transitory computer readable medium 602 may also be communicatively coupled to data sources 612 over the network 608. The data sources 612 may include, for example, databases and computing devices. The data sources 612 may be used by the database administrators and other users to communicate with the processing resource 604.

In one example, the non-transitory computer readable medium 602 includes a set of computer readable and executable instructions, such as the engines 202. The set of computer readable instructions, referred to as instructions hereinafter, may be accessed by the processing resource 604 through the communication link 606 and subsequently executed to perform acts for network service insertion.

For discussion purposes, the execution of the instructions by the processing resource 604 has been described with reference to various components introduced earlier with reference to description of FIG. 3.

On execution by the processing resource 604, the receiving engine 204 may receive the request for fetching the web document from a server. Further, the classification engine 206 may identify a plurality of contents in the web document by analyzing the document layout of the web document. In the illustrated example, the classification engine 206 may further classify each identified contents as one of relevant or non-relevant for printing based on metadata associated with the content. In one example, the classification engine 206 may employ machine learning techniques to analyze the metadata. Finally, the printing engine 210 may print the contents that are classified as relevant for printing.

Although aspects for methods and systems for printing relevant content in the web document have been described in a language specific to structural features and/or methods, the invention is not necessarily limited to the specific features or methods described. Rather, the specific features and methods are disclosed as examples for printing relevant content.

I/We claim:

1. A method comprising:
receiving, by a user device, a web document including a plurality of contents;
classifying each of the plurality of contents as one of a relevant content and a non-relevant content, based on metadata associated with each of the plurality of contents by using machine learning techniques on the metadata; and
printing the contents classified as relevant.

2. The method as claimed in claim 1, further comprising analyzing a document layout of the web document to identify the plurality of contents.

3. The method as claimed in claim 2, wherein analyzing comprises associating an identifier to each of the plurality of content

4. The method as claimed in claim 3, further comprising obtaining a user's feedback on the classification.

5. The method as claimed in 4, further comprising printing the contents classified as relevant based on the users feedback on the classification.

6. The method as claimed in claim 4, further comprises generating an input interface for each identifier to obtain the user's feedback.

7. A user device comprising:
a receiving engine to receive a web document including a plurality of contents upon receipt of a user's request;
a classification engine to classify each of the plurality of contents as one of a relevant content and a non-relevant content for printing, based on metadata associated with each of the plurality of contents using machine learning techniques;
an interactive user-interface device to receive an input from the user, wherein the interactive user-interface device renders a preview of the web document to the user indicating the classification of the plurality of contents to obtain a user's feedback on the classification; and
a printing engine to print the contents classified as relevant for printing based on the user's feedback.

8. The user device as claimed in claim 7, wherein the classification engine analyzes a document layout of the web document to identify the plurality of contents.

9. The user device as claimed in claim 7, wherein the classification engine associates an identifier to each of the plurality of content.

10. The user device as claimed in claim 9, wherein the classification engine generates an input interface for each identifier to obtain user's feedback.

11. The user device as claimed in claim 7, wherein the request by the user includes user defined parameters and wherein the printing engine prints the contents classified as relevant for printing based on user defined parameters.

12. A non-transitory computer-readable medium comprising computer-readable instructions for printing a web document, when executed by a processing resource, cause the processing resource to:
receive, by a user device, a request from a user to fetch a web document from a server;
analyze a document layout of the web document for identifying a plurality of contents in the web document;
classify each of the plurality of contents as one of a relevant content and a non-relevant content for printing based on a metadata associated with each of the plurality of contents, wherein classifying comprises analyzing the metadata associated with the plurality of contents using machine learning techniques; and
printing the contents classified as relevant.

13. The non-transitory computer-readable medium as claimed in claim 12, wherein the processing resource associates an identifier to each of the plurality of contents.

14. The non-transitory computer-readable medium as claimed in claim 13, wherein the processing resource generates an input interface for each identifier to obtain user's feedback.

15. The non-transitory computer-readable medium as claimed in claim 12, wherein the request by the user includes defined parameters and wherein the processing resource prints the contents classified as relevant for printing based on user defined parameters.
